(19) United States
(12) Patent Application Publication
(10) Pub. No.: US 2017/0110000 A1
(43) Pub. Date: Apr. 20, 2017

(54) SYSTEM AND METHOD OF IDENTIFYING A NUMBER OF OCCUPANTS IN A MONITORED REGION FOR EFFECTIVE EMERGENCY EVACUATION AND ASSISTANCE

(71) Applicant: Honeywell International Inc., Morristown, NJ (US)

(72) Inventors: Balamurugan Venkatesh, Hosur (IN); Kiran Reddy Singam, Bangalore (IN); Sameesh Mukundan, Calicut (IN)

(21) Appl. No.: 14/883,210

(22) Filed: Oct. 14, 2015

(51) Int. Cl. G08B 25/14; G08B 25/01; G08B 25/10

(52) U.S. Cl. CPC G08B 25/14; G08B 25/10; G08B 25/016

(57) ABSTRACT

Systems and methods of identifying a number of occupants in a monitored region can include an ambient alarm system and one or more registered user devices in the monitored region. When the ambient alarm system detects an alarm condition in the monitored region, the ambient alarm system can transmit a first signal to the one or more registered user devices, and responsive thereto, the one or more registered user devices can activate a respective Bluetooth peripheral device, and the ambient alarm system can initiate a discovery process with the one or more registered user devices, and responsive to the discovery process, each activated Bluetooth peripheral device can transmit a second signal to the ambient alarm system indicative of an identification of the respective registered user device. Based on a number of received identifications, the ambient alarm system can identify a number of occupants in the monitored region.

### FIELD

The present invention relates generally to ambient alarm systems. More particularly, the present invention relates to systems and methods of identifying a number of occupants in a monitored region for effective emergency evacuation and assistance.

### BACKGROUND

Ambient alarm systems, such as fire alarm systems, are known in the art. However, during an alarm condition in a monitored region, achieving safe evacuation of all occupants is a challenge, both for the occupants of the region and emergency responders attending the incident. These challenges are magnified more so in high-rise structures that are prevalent in almost every major city across the world.

Designing and constructing a monitored region, such as a building, to achieve total safety in the event of a major fire or other ambient emergency event is near impossible. Indeed, time may not permit safe evacuation to be fully accomplished before lives are lost.

In view of the above, systems and methods are needed to overcome the barriers to safe evacuation that are present in new and existing buildings. For example, it would be helpful if emergency responders and the like were privy to the headcount distribution of occupants inside of a building at a given point in time. However, there are currently no known systems and methods to identify such information. Accordingly, there is a continuing, ongoing need for improved systems and methods.

### BRIEF DESCRIPTION OF THE DRAWINGS

FIG. 1 is a flow diagram of a method in accordance with disclosed embodiments; and

FIG. 2 is a block diagram of a system in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include systems and methods of identifying a number of occupants in a monitored region for effective emergency evacuation and assistance. For example, some embodiments disclosed herein can include a gateway device of a wireless ambient alarm system, such as a fire alarm system, and a user device, for example, a smart phone or other personal digital assistant, with a Bluetooth peripheral device. In some embodiments, the gateway device can include a Bluetooth module device for communicating with the user device, and in some embodiments, the user device can include a software application running thereon for executing some of the methods disclosed herein.

Although systems and methods disclosed herein are described in connection with a wireless ambient alarm system, it is to be understood that embodiments disclosed herein are not so limited and can also include a wired ambient alarm system, for example, a wired fire alarm system. In these embodiments, the Bluetooth module device disclosed herein can be part of the fire system loop of the control panel of the alarm system, for example, the SLC loop. Furthermore, in these embodiments, the fire system loop can include a plurality of Bluetooth module devices that can be area or zone specific or that each can be a beacon for a predetermined number of user devices.

In some embodiments, the software application disclosed herein can include an instant alert software application that can be downloaded to or pre-loaded on the user device. Additionally or alternatively, in some embodiments, the software application disclosed herein can include an emergency mobility software application that can be downloaded to or loaded on the user device when the user device enters a monitored region. For example, in some embodiments, when a user device enters a building, a user can tap the user device to a security device, for example, a security kiosk, and the security device can download the emergency mobility software application to the user device by communicating with the user device via low range wireless data communications technology, including, but not limited to, NFC.

After entering monitored region, the user device can remain in sync with the ambient alarm system in the monitored region. Accordingly, when the ambient alarm system detects an alarm condition, for example, a fire alarm, the ambient alarm system can notify the user device, and the software application running on the user device can turn on the Bluetooth peripheral device of the respective user device. Furthermore, when the ambient alarm system detects an alarm condition, the Bluetooth module device of the gateway device can initiate a discovery process with user devices in the monitored region.

In some embodiments, during the Bluetooth discovery process, systems and methods disclosed herein can override a default Bluetooth identification of a user device, for example, a default identification name or number or a default identification alphanumeric number, and replace such default identification with an emergency identification, for example, an emergency identification name or number or an emergency identification alphanumeric number. Indeed, in some embodiments, the Bluetooth module device of the gateway device can recognize only detected emergency identifications of registered user devices in the monitored region. Accordingly, systems and methods disclosed herein can identify a number of registered user devices in the monitored region, and accordingly, a number of occupants in the monitored region. Furthermore, during the Bluetooth discovery process, systems and methods disclosed herein can identify probable location details for each of the user devices in the monitored region. For example, systems and methods can determine with which Bluetooth module device of which gateway device in a plurality of gateway devices a user device communicates and identify a probable location of the user device based on the location of the respective gateway device.

In some situations, a user device in the monitored region may be out of the range of a Bluetooth module device of a gateway device. In these embodiments, an in-range user device can synchronize a discovery process with the discovery process of the Bluetooth module device and communicate with an out-of-range user device using peer-to-peer Bluetooth communication. Accordingly, the in-range user device can relay the identification of the out-of-range user device to the Bluetooth module device. In this manner, systems and methods disclosed herein can more accurately identify a number of user devices in a monitored region.

Occupant topography distribution information or headcount distribution information can include the number of user devices identified in the monitored region and the probable locations thereof. In some embodiments, the occupant topography distribution information or the headcount distribution information can be displayed on a user device as would be desired by one of ordinary skill in the art. For example, in some embodiments, the occupant topography distribution information or the headcount distribution information can be displayed on an emergency responder's device or on an output device of the ambient alarm system, for example, an annunciator device. Indeed, in some embodiments, a gateway device can include an annunciator device and both the annunciator device and the Bluetooth module device of the gateway device can communicate with the ambient alarm system via a communications bus.

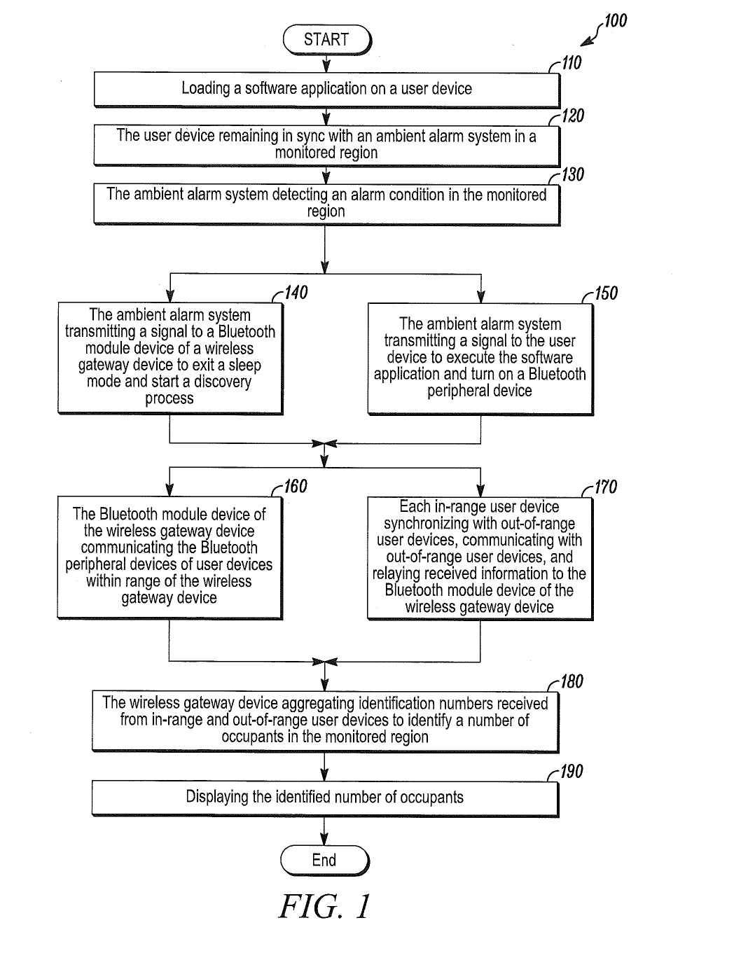

FIG. 1 is a flow diagram of a method 100 in accordance with disclosed embodiments. As seen in FIG. 1, the method 100 can include loading a software application on a user device as in 110. For example, loading the software application on the user device as in 110 can include pre-loading a software application on the user device, or a security device at the entrance of a monitored region downloading a software application to a user device upon the user device coming within a predetermined distance of the security device.

After the software application is loaded on the user device as in 110, the method 100 can include the user device remaining in sync with the ambient alarm system in the monitored region as 120. Upon the ambient alarm system detecting an alarm condition in the monitored region as in 130, the method 100 can include the ambient alarm system transmitting a signal to the Bluetooth module device of the wireless gateway device with instructions to exit a sleep mode and start a discovery process as in 140 and the ambient alarm system transmitting a signal to the user device with instructions to execute the software application running thereon and to turn on a Bluetooth peripheral device of the user device as in 150. In some embodiments, the user device executing the software application running thereon as in 150 can include the software application overriding a default identification of the user device or the associated Bluetooth peripheral device with a predetermined emergency identification that is recognizable by the Bluetooth module device of the wireless gateway device.

As seen in FIG. 1, after the Bluetooth module device of the wireless gateway device exits the sleep mode as in 140 and after the Bluetooth peripheral device of the user devices is turned on as in 150, the method 100 can include the Bluetooth module device of the wireless gateway device communicating with the Bluetooth peripheral devices of user devices within range of the wireless gateway device to identify an identification, for example, an emergency identification name, number, or alphanumeric number, of each of the in-range user devices as in 160. In some embodiments, the Bluetooth module device as disclosed herein can identify detected identifications that are not associated with a registered user device and discard such identifications for subsequent headcount identification. For example, the Bluetooth module device can identify non-emergency identifications and discard the same.

While the Bluetooth module device of the wireless gateway is communicating with the Bluetooth peripheral devices of in-range user devices as in 160, the method 100 can include each in-range user device synchronizing with out-of-range user devices, communicating with such devices to identify an identification, for example, an emergency identification, name, number, or alphanumeric number, of each of the out-of-range user devices, and relaying such identifications to the Bluetooth module device of the wireless gateway device as in 170. In some embodiments, the software application running on each in-range user device or the Bluetooth peripheral device of each in-range user device can identify detected identifications that are not associated with a registered out-of-range user device and discard such identifications for subsequent headcount identification. For example, the software application or the Bluetooth peripheral device can identify non-emergency identifications and discard the same.

As seen in FIG. 1, the method 100 can include the wireless gateway device aggregating the identifications received from both in-range user devices and out-of-range user devices to identify a number of occupants in the monitored region as in 180. Indeed, the number of Bluetooth peripheral devices and user devices discovered by the Bluetooth module device of the wireless gateway device, either directly or via another user device, can be proportional to a number of occupants inside of the monitored region. Then, method 100 can include displaying the identified number of occupants as in 190. For example, in some embodiments, the method 100 can include displaying the identified number of occupants on a user interface device of an annunciator device or on a user interface device of an emergency responder's device.

It is to be understood that some systems and methods disclosed herein can include a plurality of wireless gateway devices, each of which can include a Bluetooth module device. In these embodiments, each Bluetooth module device and wireless gateway device can execute the method 100 as described above. Then, each wireless gateway device can transmit a signal to a central device of the ambient alarm system indicative of each of the identifications identified by the wireless gateway device. The central device can filter the identifications received from each of the wireless gateway devices to delete duplicates and aggregate the total number of unique identifications to identify a number of occupants in the monitored region.

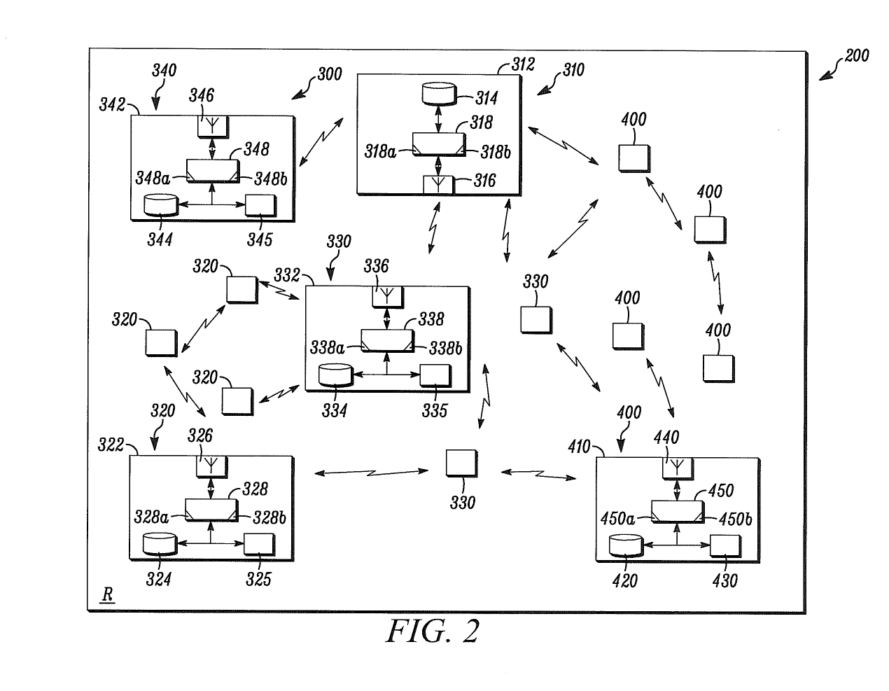

FIG. 2 is a block diagram of a system 200 in accordance with disclosed embodiments. As seen in FIG. 2, the system 200 can include an ambient alarm system 300 in a monitored region R and a plurality of user devices 400 in the monitored region.

The ambient alarm system 300 can include a central control panel device 310, one or more ambient condition detector devices 320, one or more wireless gateway devices 330, and one or more display devices 340. Each of the ambient condition detector devices 320 can communicate with the central control panel device 310 via a respective wireless gateway device 330.

As seen in FIG. 2, the central control panel device 310 can include a housing 312, a memory device 314, a transceiver 316, control circuitry 318, one or more programmable processors 318a, and executable control software 318b as would be understood by one of ordinary skill in the art. The executable control software 318b can be stored on a transitory or non-transitory computer readable medium, including, but not limited to, local computer memory, RAM, optical storage media, magnetic storage media, flash memory, and the like. In some embodiments, the control circuitry 318, the programmable processor 318a, and the control software 318b can execute and control some of the methods as described above and herein.

As further seen in FIG. 2, each of the ambient condition detector devices 320 can include a housing 322, a memory device 324, an ambient condition sensor 325, a transceiver 326, control circuitry 328, one or more programmable processors 328a, and executable control software 328b as would be understood by one or ordinary skill in the art. The executable control software 328b can be stored on a transitory or non-transitory computer readable medium, including, but not limited to, local computer memory, RAM, optical storage media, magnetic storage media, flash memory, and the like. In some embodiments, the control circuitry 328, the programmable processor 328a, and the control software 328b can execute and control some of the methods as described above and herein.

As further seen in FIG. 2, each of the wireless gateway devices 330 can include a housing 332, a memory device 334, a Bluetooth module device 335 or adaptor, a transceiver 336, control circuitry 338, one or more programmable processors 338a, and executable control software 338b as would be understood by one or ordinary skill in the art. It is to be understood that the Bluetooth module device 335 can include a Bluetooth transceiver that may be separate from the transceiver 336. The executable control software 338b can be stored on a transitory or non-transitory computer readable medium, including, but not limited to, local computer memory, RAM, optical storage media, magnetic storage media, flash memory, and the like. In some embodiments, the control circuitry 338, the programmable processor 338a, and the control software 338b can execute and control some of the methods as described above and herein.

The display device 340 can include a housing 342, a memory device 344, a user interface device 345, a transceiver 346, control circuitry 348, one or more programmable processors 348a, and executable control software 348b as would be understood by one or ordinary skill in the art. The executable control software 348b can be stored on a transitory or non-transitory computer readable medium, including, but not limited to, local computer memory, RAM, optical storage media, magnetic storage media, flash memory, and the like. In some embodiments, the control circuitry 348, the programmable processor 348a, and the control software 348b can execute and control some of the methods as described above and herein. Although the display device 340 is shown as a standalone device in FIG. 2, it is to be understood that the display device 340 can additionally or alternatively be part of the central control panel device 310, an ambient condition detector device 320, a wireless gateway device 330, an emergency responder's device, such as a smart phone, or any other output device inside or outside of the monitored region R, such as an annunciator device.

As seen in FIG. 2, each of the plurality of user devices 400 can include a housing 410, a memory device 420, a Bluetooth peripheral device 430, a transceiver 440, control circuitry 450, one or more programmable processors 450a, and executable control software 450b as would be understood by one or ordinary skill in the art. It is to be understood that the Bluetooth peripheral device 430 can include a Bluetooth transceiver that may be separate from the transceiver 440. It is also to be understood that the executable control software 450b can include the instant alert software application or the emergency mobility software application described above. The executable control software 450b can be stored on a transitory or non-transitory computer readable medium, including, but not limited to, local computer memory, RAM, optical storage media, magnetic storage media, flash memory, and the like. In some embodiments, the control circuitry 450, the programmable processor 450a, and the control software 450b can execute and control some of the methods as described above and herein.

In some embodiments, the executable control software 450b can be loaded on each of the user devices 400, and each of the user devices 400 can remain in sync with the ambient alarm system 300, including the central control panel device 310. When at least one of the ambient condition detector devices 320 detects an alarm condition in the monitored region R, the detector device 320 can transmit a signal to a respective wireless gateway device 330, which can relay the signal to the central control panel device 310. When the wireless gateway device 330 receives the signal form the detector device 320, the gateway device 330 can cause its associated Bluetooth module device 335 to exit a sleep mode and start a discovery process. Furthermore, when the central control panel device 310 receives the signal from the gateway device 330, the central control panel device 310 can transmit a signal to each of the other wireless gateway devices 330 to cause the respective Bluetooth module devices 335 to exit a sleep mode and start a discovery process. The central control panel device 310 can also transmit a signal to each of the user devices 400 in the monitored region R to cause the devices 400 to execute a respective control software 450b running thereon and to turn on a respective Bluetooth peripheral device 430.

During the discovery process, each of the Bluetooth module devices 335 can communicate with Bluetooth peripheral devices 430 of user devices 400 within a predetermined range of the respective Bluetooth module device 335 to transmit signals indicative of identifications of the in-range user devices 400 to a respective wireless gateway device 330. During the discovery process, each of the Bluetooth peripheral devices 430 of user devices 400 within the predetermined range of a Bluetooth module device 335 can also communicate with Bluetooth peripheral devices 430 of user devices 400 outside of a predetermined range of Bluetooth module devices 335 in the monitored region R to relay signals indicative of identifications of the out-of-range user devices 400 to a respective wireless gateway device 330. Accordingly, each of the wireless gateway devices 330 can identify at least some of the identifications of user devices 400 in the monitored region R.

Each of the wireless gateway devices 330 can transmit a signal indicative of the received identifications to the central control panel device 310, which can filter received identifications to delete duplicates and aggregate the total number of unique identifications to identify a number of occupants in the monitored region R. The central control panel device 310 can also identify a probable location of each occupant based on the location of the respective wireless gateway device(s) 330 that transmitted a signal indicative of an identification of a respective user device 400 to the central control panel device 310. Finally, the central control panel device can transmit a signal to the display device 340 for with instructions displaying, on the user interface device 345, the identified number of occupants in the monitored region R and the probable location thereof.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

What is claimed is:

1. A method comprising:
receiving a first signal indicative of an alarm condition in a monitored region;
responsive to receiving the first signal, initiating a discovery process with registered user devices in the monitored region;
receiving a second signal from each of a plurality of registered user devices in the monitored region, the second signal indicative of one or more identifications of one or more respective registered user devices; and
based on a number of received identifications, identifying a number of occupants in the monitored region.

2. The method of claim 1 wherein receiving the first signal includes receiving the first signal from an ambient condition detector device in the monitored region or receiving the signal from a central control panel device in the monitored region.

3. The method of claim 1 further comprising, responsive to receiving the first signal, causing a Bluetooth module device to exit a sleep mode.

4. The method of claim 1 wherein receiving the second signal from each of the plurality of registered user devices includes receiving the second signal from one or more in-range user devices.

5. The method of claim 4 wherein the second signal is indicative of an identification of a respective in-range user device and a respective out-of-range user device.

6. The method of claim 1 wherein identifying the number of occupants in the monitored region includes transmitting a third signal indicative of the number of received identifications to a central control panel device for identification of the number of occupants in the monitored region.

7. The method of claim 6 further comprising identifying a location of each of the registered user devices in the monitored region based on an origin location of the third signal transmitted to the central control panel device.

8. The method of claim 1 further comprising transmitting a third signal with instructions to display an indication of the identified number of occupants in the monitored region.

9. A method comprising:
receiving a first signal indicative of an alarm condition in a monitored region;
responsive to receiving the first signal, activating a Bluetooth peripheral device;
receiving a second signal from a Bluetooth module device of a wireless gateway device indicative of a discovery process; and
responsive to receiving the second signal, transmitting an identification signal to the Bluetooth module device via the Bluetooth peripheral device.

10. The method of claim 9 wherein receiving the first signal includes receiving the first signal from a central control panel device in the monitored region.

11. The method of claim 9 wherein activating the Bluetooth peripheral device includes executing a software application stored on a non-transitory computer readable medium.

12. The method of claim 11 further comprising downloading the software application to the non-transitory computer readable medium upon entry to the monitored region.

13. The method of claim 12 further comprising, responsive to downloading the software application, synchronizing with an ambient alarm system in the monitored region.

14. The method of claim 11 wherein executing the software application stored on the non-transitory computer readable medium includes replacing a default identification with an emergency identification, and wherein transmitting the identification signal includes transmitting the emergency identification.

15. The method of claim 9 further comprising, responsive to receiving the second signal, synchronizing with an out-of-range user device, receiving an identification of the out-of-range user device, and relaying the received identification of the out-of-range user device to the Bluetooth module device via the Bluetooth peripheral device.

16. A system comprising:
an ambient alarm system in a monitored region; and
one or more registered user devices in the monitored region,
wherein, when the ambient alarm system detects an alarm condition in the monitored region, the ambient alarm system transmits a first signal to the one or more registered user devices, and responsive thereto, the one or more registered user devices activate a respective Bluetooth peripheral device,
wherein, when the ambient alarm system detects the alarm-condition in the monitored region, the ambient alarm system initiates a discovery process with the one or more registered user devices,
wherein, responsive to the discovery process, each activated Bluetooth peripheral device of the one or more registered user devices transmits a second signal to the ambient alarm system indicative of an identification of the respective registered user device, and
wherein, based on a number of identifications in the received second signals, the ambient alarm system identifies a number of occupants in the monitored region.

17. The system of claim 16 wherein the one or more registered user devices activating the respective Bluetooth peripheral device includes replacing a default identification with an emergency identification, and wherein the second signal is indicative of the emergency identification of the respective registered user device.

18. The system of claim 17 wherein the ambient alarm system disregards received identifications that are not emergency identifications.

19. The system of claim 16 wherein each activated Bluetooth peripheral device synchronizes with a plurality of activated Bluetooth peripheral devices, receives an identification signal from each of the synchronized Bluetooth peripheral devices, and relays the received identification signals to the ambient alarm system in the second signal.

20. The system of claim 16 wherein the ambient alarm system identifies a location of the one or more registered user devices based on a location at which the ambient alarm system receives the second signal.
